(19) United States
(12) Patent Application Publication
(10) Pub. No.: US 2007/0066483 A1
(43) Pub. Date: Mar. 22, 2007

(54) Plant Nourishing

(76) Inventor: Meghan Gibson, Norfolk, MA (US)

Correspondence Address: FISH & RICHARDSON PC, P.O. BOX 1022, MINNEAPOLIS, MN, 55440-1022, US

(21) Appl. No.: 11/535,771

(22) Filed: Sep. 27, 2006

Related U.S. Application Data
(62) Division of application No. 10/921,431, filed on Aug. 18, 2004.

(51) Int. Cl. A01N 3/02

(52) U.S. Cl. 504/115

(57) ABSTRACT

In one aspect, the invention is a mixture for nourishing a plant, including, e.g., a cut plant or flower. The mixture includes sugar, and citric acid and/or potassium. The mixture may include water. In another aspect, the invention is a method for nourishing a plant. The method includes providing a predetermined quantity of the mixture to a plant, e.g., by inserting a cut end of the plant stem into the mixture and water.

### CROSS-REFERENCE TO RELATED APPLICATIONS

This application is a divisional (and claims the benefit of priority under 35 USC 120) of U.S. application Ser. No. 10/921,431, field Aug. 18, 2004. The disclosure of the prior application is considered part of (and is incorporated by reference in) the disclosure of this application.

### TECHNICAL FIELD

This disclosure relates to nourishing plants.

### BACKGROUND

A plant like other living organisms requires nutrients to survive. The nutrients may be provided by sunlight, water and fertilizer. Even though an unbloomed flower is cut from a plant, the cut flower may still bloom if supplied with nutrients.

### SUMMARY

In one aspect, the invention is a mixture for nourishing a plant. The mixture includes sugar, and citric acid and/or potassium.

In another aspect, the invention is a method for nourishing a plant. The method includes providing a predetermined quantity of a mixture to a plant. The mixture includes sugar and citric acid and/or potassium.

The aspects above may have one or more of the following advantages. Adding a mixture that includes sugar, and citric acid and/or potassium increases the life of a plant. The freshness of cut flowers will last longer thereby reducing the cost over time of replenishing fresh flowers with newer cut flowers as well as extending the enjoyment of the cut flowers.

Other features, objects and advantages will become apparent from the following detailed description when read in connection with the accompanying drawings.

### DESCRIPTION OF THE DRAWINGS

FIG. 1A is a view of a plant.

FIG. 1B is a cross-sectional diagram of a stem of the plant.

FIG. 2 is a flow diagram of a process to nourish the plant.

FIG. 3 is a table recording conditions of carnations over time using different mixtures

FIG. 4 is bar graph of the time the carnations were preserved.

### DESCRIPTION

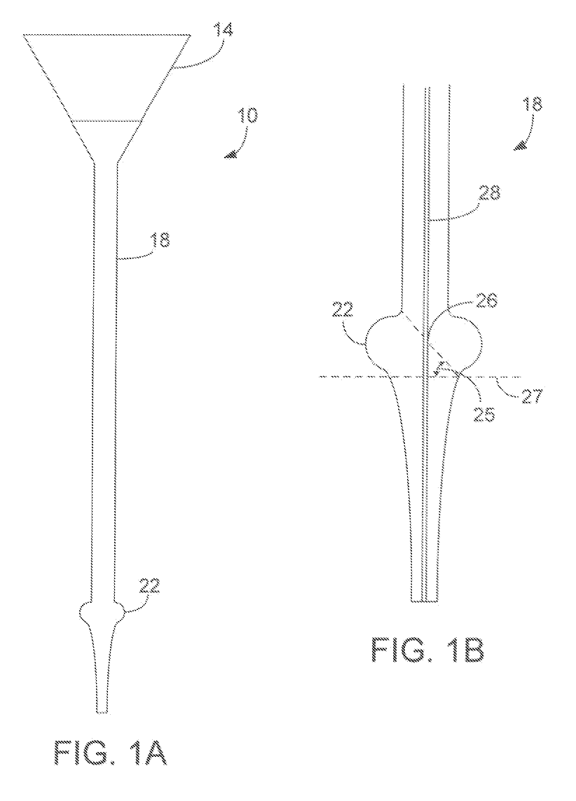

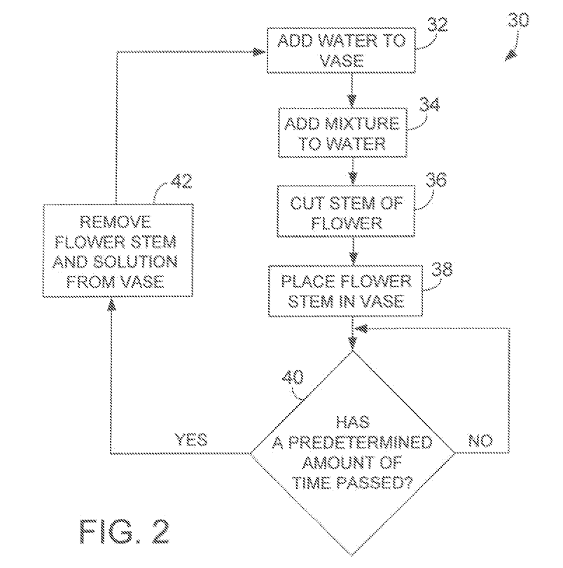

Referring to FIGS. 1A and 1B, a flowered plant 10 (e.g., a carnation) includes a flower 14 and a stem 18. The stem 18 includes a knob 22 and a tube 28. The knob is a bump found along a stem. The tube is a channel that transports nutrients from one end of the stem 18 to the flower 14. As will be described below, a process 30 (FIG. 2) is used to nourish the plant 10. In this disclosure, nourishing a cut flower is described; however, it is understood that any form of plant may be nourished using the mixtures and techniques described herein.

Referring to FIG. 2, process 30 includes the step of adding (32) water to a vase. For example, a user adds one cup of warm distilled water to a vase. Distilled water does not contain harmful substances to the flowers such as lead, copper, chlorine, fluoride, minerals, and so forth. According to process 30, mixture is added (34) to the water in the vase to form a solution. The mixture may include sugar. The mixture may also include citric acid or potassium or both. In other embodiments, the mixture includes sugar, citric acid and potassium (e.g., a sports drink such as GATORADE). The mixture may also include sodium.

The stem 18 is cut (360 at an angle 25 along dotted line 26 through knob 22 with a sharp knife. The angle is measured from an axis 27 extending perpendicular to the stem 18 to the dotted line 26. The stem 18 is cut at the angle 25 through the knob 22 to allow more surface area of the base of the stem 18 to be exposed thereby allowing the plant to receive more nutrients. The angle 25 may be between 20 degrees to 75 degrees. Cutting the stem 18 opens a tube 28. The tube 28 is used by the plant 10 to transport nutrients through the stem 18 to the flower 14. Warm water causes the tube 28 to stay open and facilitates transport of nutrients. The knife is used rather than scissors because scissors may sometimes crush the tubes thereby blocking the flow of nutrients through the stem.

The stem is placed (38) into the vase. For example, the stem is placed into the vase within five seconds of the cutting to ensure that air pockets do not form.

If it is determined (40) that a predetermined amount of time has passed, e.g., a day or a few days, the flower stem and the solution are removed (42) and blocks 34 to 38 are repeated to add a fresh mixture thereby further extending the life of the plant.

Experiment:

The materials in the experiment used included seven vases; one cutting knife; one teaspoon each of lemon-lime soda, sugar, aspirin, house bleach, vitamins, a sports drink, including citric acid, potassium, sodium, sugar and water, eight cups of warm distilled water, and seven fresh carnations

Each of the seven vases were filled with 1 cup of distilled water. One teaspoon of each additive was added to its own separate vase of distilled water. One vase only contained distilled water because it was used as the control group. Each carnation was cut on the end at a slant. One carnation was placed into each vase within 5 seconds of the cutting so that air pockets do not develop.

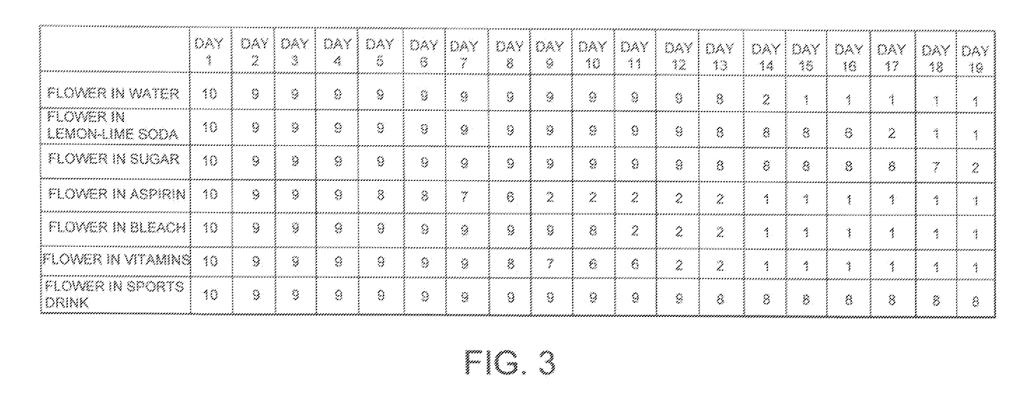

Referring to FIG. 3, the conditions of each flower were recorded after every 24-hour period on a scale from “1” to “10.” Scores between “7” to “10” are “good,” scores between “4” to “6” are “fair,” and scores between “0” to “3” are poor.

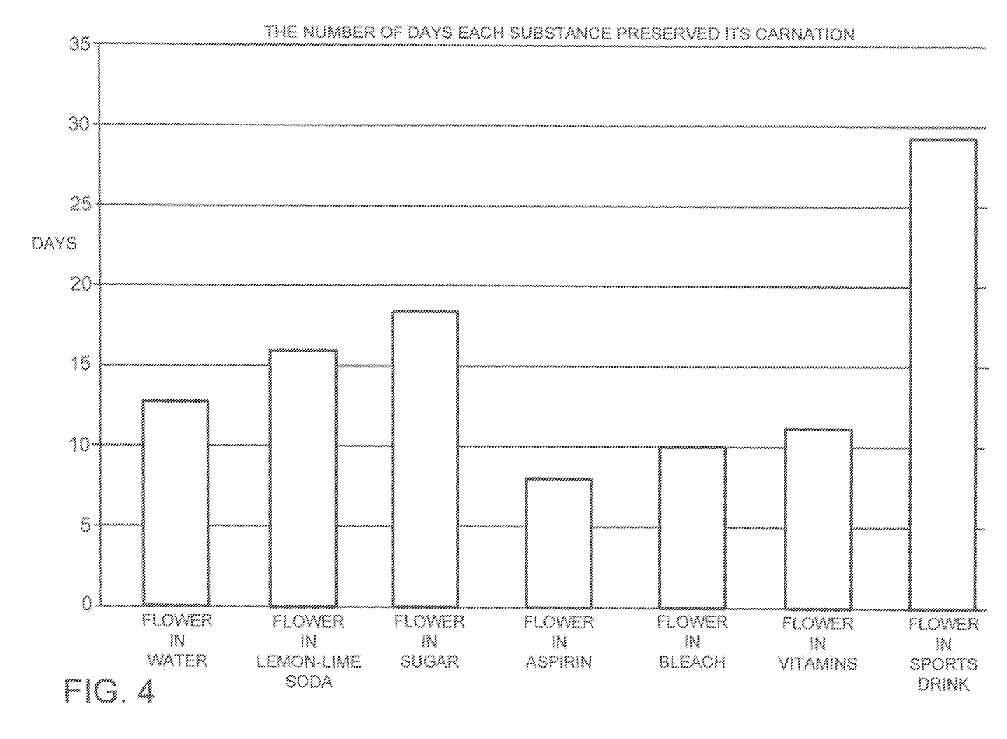

Referring to FIGS. 3 and 4, the first flowers to collapse were the solutions containing water with aspirin and water with bleach. A flower was “collapsed” when it decayed to a point where the flower 14 fell to a side of the stem 18. Aspirin is recommended to preserve flowers by many florists because it lowers the PH level of water, making it more acidic. Acid helps water move more easily up the tubes in a flower's stem 18. However, some florists argue that aspirin can damage flowers, which this experiment supported. Bleach was used in the experiment because bleach kills bacteria, which is harmful to flowers. However, the bleach and water solution only preserved its flower for ten out of nineteen days. The next flower to collapse were the flowers with vitamins and water solution and the control group (water only). The carnation with vitamins and water solution may have collapsed because of bacteria growth that developed in the vase. The control group (water only) preserved its carnation for an average length of thirteen days. Furthermore, the last three flowers to remain fresh were the flowers kept in the water and sugar solution; water and the lemon-lime soda solution; and the water and the sports drink solution. All three solutions contained sugar, a vital substance needed by plants to carry out photosynthesis. The flower with the lemon lime soda lasted for sixteen days, and the flower with sugar lasted for eighteen days. The sports drink and water was the solution that preserved its flower the longest, approximately twenty-nine days.

From this experiment, it was concluded that the sports drink includes ingredients for extending the display of flowers. The sports drink includes sugar, used by plants for photosynthesis. The sports drink also includes citric acid, which lowers the PH level of water. With acids, water can move up the flower's stem quickly. The sports drink also contains potassium, which is also found in fertilizer.

Process 30 is not limited to the specific embodiments described herein. For example, process 30 may be used on plants other than flowered plants. The flowers need not be cut. Process 30 may be performed by a machine or by a human being.

The process is not limited to the specific processing order of FIG. 2. Rather, the blocks of FIG. 2 may be re-ordered, combined or omitted, as necessary, to achieve the results set forth above. For example, the user may choose not to change-out the water and/or re-cut the stem. The distilled water, citric acid and the potassium may be combined prior to adding to the vase. The stem of the flower may be cut before the water and the mixture are combined and added to the vase and so forth.

There has been described novel mixtures and techniques for nourishing a plant. It is evident that those skilled in the art may now make numerous modifications and uses of and departures from specific mixtures and techniques herein disclosed without departing from the inventive concepts. Consequently, the invention is to be construed as embracing each and every novel feature and novel combination of features present in or processed by the apparatus and techniques herein disclosed and limited solely by the spirit and scope of the appended claims.

1-13. (canceled)

14. A method for preserving a cut flower, the method comprising:
placing a plant in a receptacle holding water; and providing a predetermined quantity of a mixture to the water, the mixture comprising:
sugar;
potassium; and
citric acid.

15. The method of claim 14, wherein the plant includes a stem and the method further comprises:
cutting the stem of the flower at an angle not perpendicular to an axis extending along the stem; and
placing a cut end of the stem in a vase containing the mixture and the water.

16. The method of claim 14, wherein the mixture further comprises water.

17. The method of claim 16, wherein the water is distilled water.

18. The method of claim 16, wherein the water measures about one cup and the sugar and the sugar, potassium and citric acid together measure about one teaspoon.

19. The method of claim 16, wherein the mixture is a sports drink.

20. The method of claim 14 wherein the plant is a carnation.
